(19) United States
(12) Patent Application Publication
(10) Pub. No.: US 2025/0307274 A1
(43) Pub. Date: Oct. 2, 2025

(54) SYSTEM AND METHOD FOR DATA MINING AND EXPLORATION

(71) Applicant: NOVACENE AI CORP., Ottawa (CA)

(72) Inventors: Marcelo Fabian Bursztein, Ottawa (CA); Rebecca Sarah Langstone, Ottawa (CA)

(73) Assignee: NOVACENE AI CORP., Ottawa, ON (CA)

(21) Appl. No.: 19/049,099

(22) Filed: Feb. 10, 2025

Related U.S. Application Data
(60) Provisional application No. 63/569,844, filed on Mar. 26, 2024.

(51) Int. Cl. G06F 16/28; G06F 3/0484; G06F 16/23

(52) U.S. Cl. CPC G06F 16/287; G06F 3/0484; G06F 16/2365

(57) ABSTRACT

A system and method for data exploring enables a user to utilize existing raw and unstructured data, upload it to the system explore it to gain relevant insights. The system is comprised of enrichers that utilize ML and AI to transform the data into enriched data. Once the data has been enriched, the system displays the results through widgets, alongside structured and unstructured data. The widgets are explorable and navigable by a user in the sense that selecting one datapoint on one widget filters the other widgets accordingly, such that the user can gain insights on their original dataset. The system also has an interactive Q&A functionality that leverages LLM for users to query their data. In the Q&A, the system uses RAG methodology to retrieve semantically similar results and run them through a LIM to provide insightful, helpful and cited answers.

### CROSS-REFERENCE TO RELATED APPLICATION

The present application claims priority to U.S. Provisional Application No. 63/569,844, titled “SYSTEM AND METHOD FOR DATA MINING AND EXPLORATION” filed on Mar. 26, 2024, the contents of which are incorporated herein by reference in their entirety.

### FIELD

The invention relates generally to data analytics systems and more particularly, to system and method for data mining and exploration using natural language processing.

### BACKGROUND

Data analytics has been an especially busy, crowded field since the advent of computers to read and decipher the data faster and more efficiently. Companies often employ teams of data scientists that collect data, then create and customize text analysis algorithms to filter out the noise and generate useful information.

With the acceleration of AI research, and particularly Natural Language Processing (NLP) thanks to the availability of increased computing power, generation of massive amounts of data, and academic focus, AI tools have been utilized more frequently to parse through the data and generate useful insights. But foundation models and transfer learning are not enough. Effective AI requires careful fine tuning to ensure it performs well across different datasets.

Indeed, there is a need for a platform, and more specifically a system and a method, to convert raw, unstructured text to generate meaningful insights quickly and effectively. This system must also allow for the analysis of structured data in conjunction with the analysis of unstructured data. There is also a need for the results to be explorable and navigable in a way that is intuitive and easy to understand, and that does not require data scientists. The information should be able to be analyzed and reviewed by any data analyst that can choose to focus on subsets of the data for exploration, and quickly navigate from a general overview to specific or tangential insights and back again. There is also a need for such a non-data-scientist user to find insights in the data through AI tools, interactive visualization, and queries.

There are also other problems inherent in these data mining system regarding data correction. First, there is an inability to collect predictions in one place for convenient review: existing systems allow users to review predictions by opening an enriched dataset. Currently, these systems create one enriched dataset for each enrichment job, even when these jobs use the same enricher. This process may work well when one same enricher is applied to distinct datasets (e.g. when applying sentiment analysis to a survey dataset versus a product reviews dataset). However, creating multiple enriched datasets for a single enrichment type applied to an ongoing enrichment process prevents the collection of all the predictions that are related to one same use case in a centralized place. Second, there is an inability to improve training datasets with user corrections: each training iteration will require a larger and more accurate training dataset than the one used the last time the model was trained. Currently, these systems provide the ability for users to train multiple versions of an enrichment type using different training datasets. However, adding cases to a training dataset cannot be accomplished within the systems. The same is true for using the corrections to rectify any mislabels that might exist in the training dataset. Further, the user must carefully keep track of training and testing datasets offline, using external tools. Third, there is an inability to improve testing datasets with user corrections: users will need to be able to compare the performance of the old model against the performance of the newly trained model. For the evaluation to be relevant, both models must be evaluated using the same testing data. To combat overfitting (i.e. testing with not enough data) it is necessary for the test dataset to contain as many user-verified samples as possible. Currently, systems allow users to evaluate the performance of binary and multiclass classification models; however, this functionality requires that users provide a testing dataset each time they wish to run an evaluation.

As such, there is a need for a corrections functionality to overcome the aforementioned problems.

### SUMMARY

In an aspect, the present disclosure provides a method of exploring data, the steps comprising: receiving at least one dataset; running an enricher on the at least one dataset, the enricher utilizing at least one of: machine learning, algorithms and artificial intelligence models, to transform the at least one dataset into an enriched dataset; generating a visual representation of the enriched dataset on a platform, the visual representation containing a plurality of widgets, the plurality of widgets displayed on the platform and configured to be explorable and navigable by a user to determine insights of the at least one dataset.

In another aspect, the present disclosure provides a system for exploring data using a platform, the system comprising: a processor; a memory communication with the processor, the memory comprised of computer executable instructions that, when executed by the processor, cause the processor to: receive the data; enrich the data to transform the data into an enriched dataset; and, generate a visual representation of the enriched dataset on a platform, the visual representation containing a plurality of widgets, the plurality of widgets displayed on the platform being explorable and navigable by a user to determine insights of the data.

In yet another aspect, the present disclosure provides a method of querying data using a platform, the steps comprising: receiving the query from a user and embedding the query; communicating with a database and retrieving embeddings based on the embedded query; sending the query and the embeddings to a large language model (LLM) for processing; and, returning a generative answer to the query.

In yet another aspect, the present disclosure provides a method of improved training of a model using a platform, the steps comprising: receiving a dataset; building a training dataset, a testing dataset and an enriched dataset; training the model using the training dataset, the model making predictions stored in the enriched dataset; receiving input from a user based on the predictions; storing the input in a cloned dataset, the cloned dataset being cloned from the enriched dataset; and, merging the input from the cloned dataset into the training, testing and enriched datasets; wherein the training dataset trains the model and the model stores predictions into the enriched dataset, and wherein the enriched dataset learns from the input from the user and improves over time.

### BRIEF DESCRIPTION OF THE DRAWINGS

A detailed description of embodiments of the invention is provided herein below, by way of example only, with reference to the accompanying drawings, in which:

FIG. 1 is a flowchart of a system and method for data mining and exploration, according to an embodiment of the present disclosure;

FIG. 2 is a screenshot of a platform having a plurality of projects of the method of FIG. 1, according to an embodiment of the present disclosure;

FIG. 3 is a screenshot of the platform having a plurality of enrichers of the method of FIG. 1, according to an embodiment of the present disclosure;

FIG. 4 is a screenshot of the platform having a plurality of models of the method of FIG. 1, according to an embodiment of the present disclosure;

FIG. 5 is a screenshot of the platform showing matrices of the method of FIG. 1, according to an embodiment of the present disclosure;

FIG. 6 is a screenshot of the platform showing a stage page containing a plurality of explorable widgets of the method of FIG. 1, according to an embodiment of the present disclosure;

FIG. 7 is a flowchart of a question and answer (Q&A) functionality of the system and method of FIG. 1, according to an embodiment of the present disclosure;

FIG. 8 is a screenshot of a representation of the platform showing the Q&A functionality of the system and method of FIG. 1;

FIG. 9 is a flowchart of a model utilizing master datasets of a learning function of the system and method of FIG. 1, according to an embodiment of the present disclosure;

FIG. 10 is a flowchart of a user making corrections within the learning function of the system and method of FIG. 1, according to an embodiment of the present disclosure; and,

FIG. 11 is a flowchart of a user merging changes into the master datasets within the learning function of the system and method of FIG. 1, according to an embodiment of the present disclosure.

It is to be expressly understood that the description and drawings are only for the purpose of illustration of certain embodiments of the invention and are an aid for understanding. They are not intended to be a definition of the limits of the invention.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

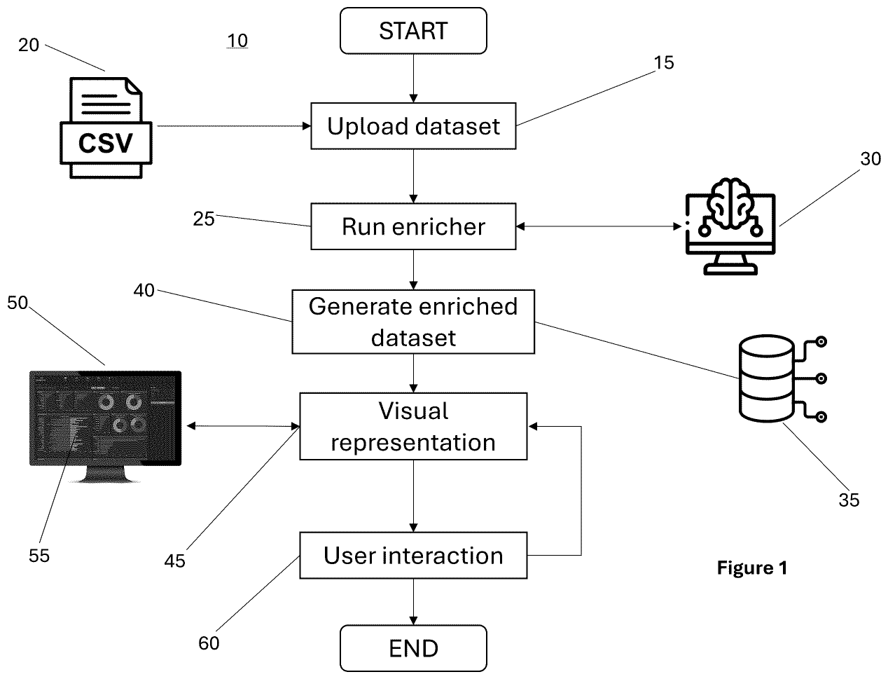

With reference to FIG. 1 and according to an embodiment of the present disclosure, a method of mining and exploring data 10 is shown. Generally, in a first step 15 of the method 10, a user provides and uploads a dataset 20. Typically, such a dataset 20 can be in csv format, although other formats are possible. In a second step 25 of the method 10, an enricher 30 is applied to the dataset 20. The enricher 30 may utilize machine learning (ML) or artificial intelligence (AI) to infer new information and data from the dataset 20. By inferring new information from the dataset 20, an enriched dataset 35 is generated in a third step 40. In a fourth step 45, the enriched dataset 35 is visually represented for a user. The visual representation can take a variety of forms but is generally a graphical user interface (GUI) 50 that contains a plurality of widgets 55. As will be further explained, the widgets 55 are explorable and navigable by a user to obtain useful information or “insights” from the enriched dataset 30. Indeed, in a fifth step 60, the user can interact with the widgets 55 within the GUI 50 to further generate insights. These new insights, which are taken from a subset of the enriched dataset 30, can be further visually represented as the GUI 50 is updated with the specific information. In this way, the datasets 20 are explorable. It is understood that the method 10 as described can be performed by a processor (not shown) in a device (not shown). The processor (not shown) would receive the uploaded dataset 20, process and run the enricher 30 on the dataset 20, the enricher 30 utilizing ML and AI models to transform the dataset 20 into an enriched dataset 35, then visually represent those results through a GUI 50 displayed on a platform 80. The processor (not shown) is configured to process user inputs to explore the results. In an embodiment, the processor (not shown) may be part of a system that would perform various aspects of the techniques described in this disclosure related to data mining and exploration. The system would be comprised of a user device (not shown) capable of running the method 10, the user device in wireless communication with a host device server and other external devices to perform the various functions. The host device may be any type of computing device capable of running the functions as described in the present disclosure. The host device may include one or more servers, execution platforms, ML/AI units and databases.

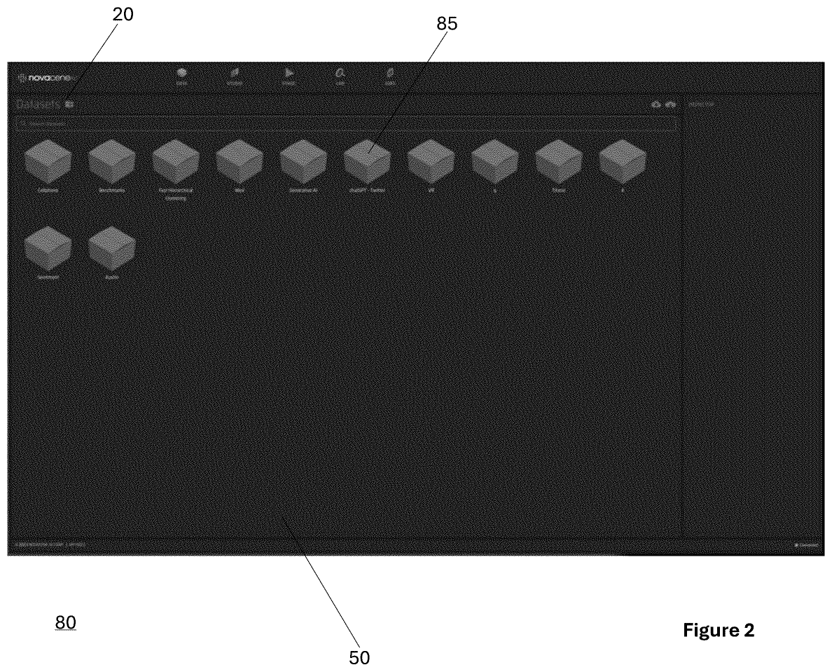

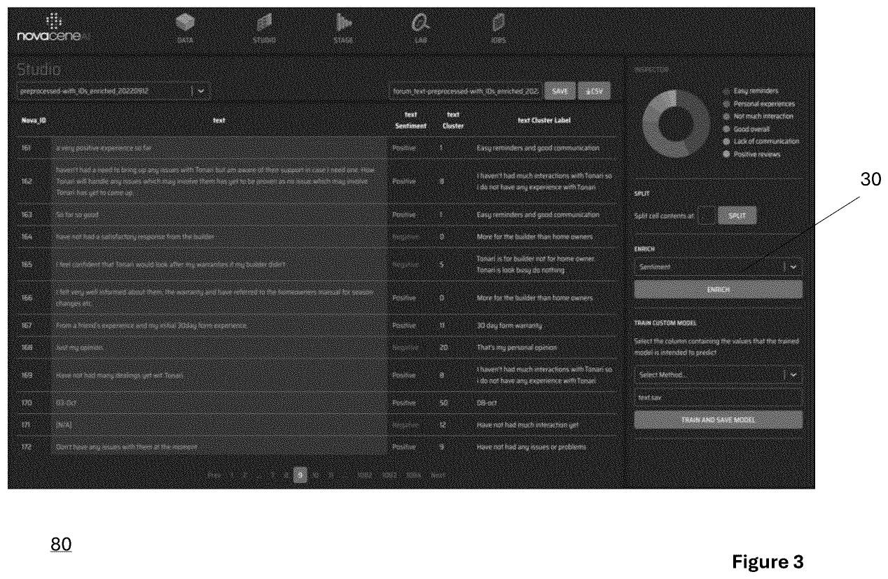

With reference to FIGS. 2, 3 and 4 and according to an embodiment of the present disclosure, a platform 80 shown, the platform is 80 being a representation of the GUI 50. It is to be understood that the platform 80 and GUI 50 are visual presentations of the functionality of the overall system. In other words, action performed and described to occur on the an platform 80 will be processed by the processor (not shown) on the device (not shown) of the system. As specifically shown in FIG. 2, information and/or data in the form of datasets 20 are uploaded onto the platform 80 and lead to the creation of projects 85. The platform 80 provides a specific page on which are loaded the datasets 20 into said projects 85. The platform 80 provides user-friendly environment for the creation, sharing, and management of the datasets 20 between users. In an embodiment, the platform 80 allows users to upload datasets 20 in the form of .csv or .zip files, or the platform 80 can also “fetch” data by entering keywords and searching third party applications or the internet generally. With specific reference to FIG. 3, once the datasets 20 have been uploaded into the platform 80, a user can “enrich” the dataset 20 using an enricher 30. A worker skilled in the art would appreciate that enrichers 30 are a combination of AI and ML models and algorithms available for transforming the datasets 20. The platform 80 has both built-in enrichers 30 that do not require training, as well as buildable enrichers 30 that can be created and trained separately. Examples of built-in enrichers 30 include, but are not limited to the following: clause extraction (splits a paragraph into clauses, allowing the application of other enrichers to the dataset 20 in a more granular way); cluster label (outputs the single most representative sample in a cluster, providing an understanding of the topic of the samples in the cluster); cluster summary (outputs a few samples formatted as a paragraph, providing context as to what the samples in the cluster are about); clustering (organizes similar text into categories, each category is represented by a number, starting with 0); peer clustering (groups together cases based on the number of shared attributes amongst them). Each time an enricher 30 is applied to the dataset 20, the platform clones the original dataset 20 and adds the results from the enrichment 30 to the clone. This is done to preserve the integrity of datasets 20 and provide the user with a trail of datasets 20 as they have been enriched.

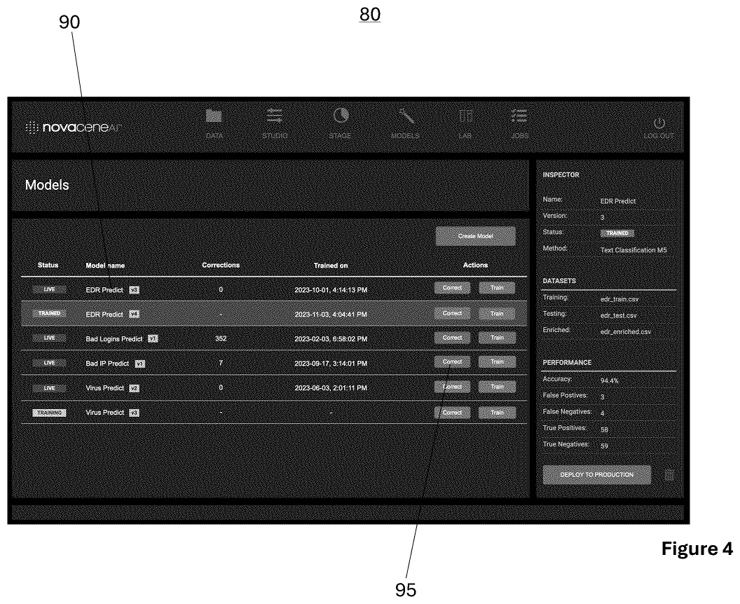

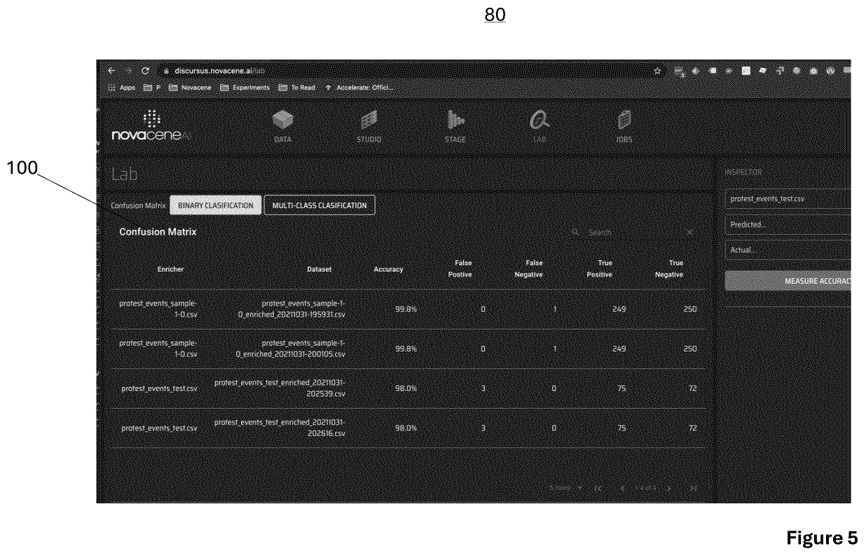

In another embodiment, the user can create a custom enricher 30 by using a specific dataset 20. The platform 80 of the system (not shown) provides a space to train a specific base model 90 by using an automatic ML feature to let the platform 80 choose the best algorithm for the user automatically. A variety of methods are provided to train a custom model 90, including: category (categorizes data having categorical values); forecasting (creates predictions that output a quantifiable value); and, text classification (classify text using two or more classes). Once a custom enricher 30 is selected, a user can instruct the system (not shown) through the platform 80 to train the model 90. Once the platform 80 has trained the model 90, the platform 80 can display and present performance metrics. Model predictions can be reviewed by the user to provide feedback and improve enrichment over time using an ongoing learning functionality (not shown). Indeed, a user can correct 95 the mispredictions made by the platform 80 and re-train the model 90. In this way, the platform 80 learns from these corrections 95 to improve over time, thereby increasing the performance of the custom model 90. With specific reference to FIG. 5, the platform 80 allows user to test the performance of a model 90 using a confusion matrix 100. Confusion matrices 100 may be available for binary and multiclass classification models. In another embodiment, the performance of a model 90 can also be shown to a user in the screen represented in FIG. 4 under “Performance”.

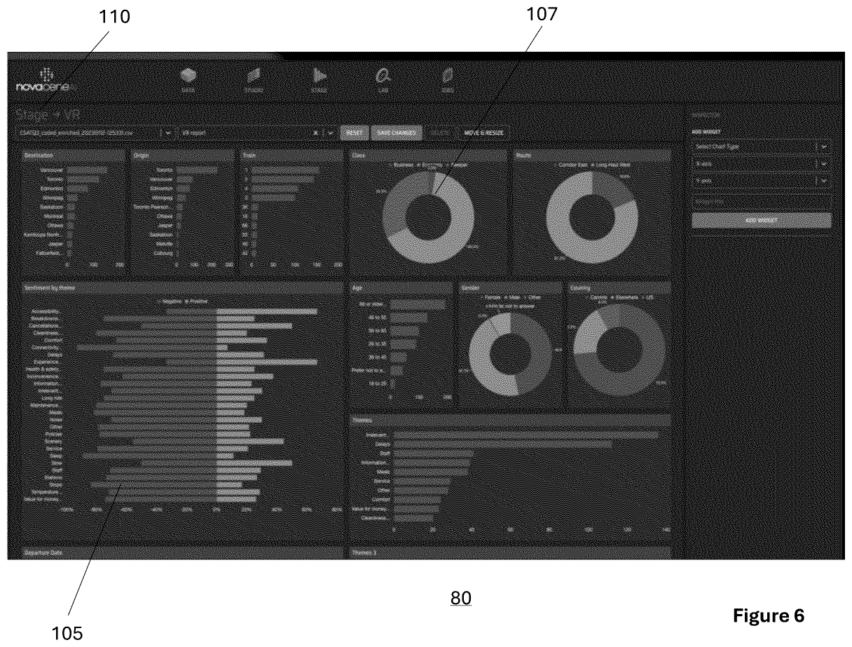

With reference to FIG. 6 and according to an embodiment of the present disclosure, once the dataset (not shown) has been enriched, the platform 80 provides a variety of widgets 105, 107 in a stage pane 110. The platform 80 is customizable in that a variety of widgets 105, 107 can be used and laid out in a plurality of arrangements. When the enriched data is first loaded, the platform 80 automatically generates widgets 105, 107 that are most likely to benefit from a visualization. The platform 80 automatically determines the type of visualization widget 105, 107 to use based on the data values. For example, fewer data points may result in a pie chart widget 107, whereas multiple data points may result in a stacked bar chart widget 105. Preferably, the platform 80 will not produce automated visualization charts where there is a single identical value across all rows, distinct values in every row, or only blank values, for example. A variety of visualization options for the widgets 105, 107 are possible, including vertical, horizontal and diverging stacked bar charts, doughnut chart, line chart, item listing, word cloud, etc.

With further reference to FIG. 6 and according to an embodiment of the present disclosure, the widgets 105, 107 are navigable and explorable. More particularly, a user of the platform 80 can select or click on an element contained in any one of the widgets 105, 107, and the system will then filter the remaining widgets 105, 107 located on the stage pane 110 accordingly. By way of example not intended to be limiting, if a user filters by “Negative Sentiment” (by selecting it in the stage pane 110), the platform 80 will update itself and the user will then see all the other text data with negative sentiment. If a widget 105, 107 is displaying a “theme” or contains any other field, such widgets 105, 107 will be updated automatically to display the negative sentiment themes or other field(s) showing negative sentiment, respectively. In this way, the widgets 105, 107 are automatically updated and filtered based on the user selection so that the user can visualize how one filter affects the displayed dataset on the other widgets. The user can add additional filters or remove the filters to go back to the originally-displayed data visualization. In this way, the data is navigable and explorable and the platform 80 will display updated widgets 105, 107 according to the filters as added or removed by the user. The widgets 105, 107 are also capable of visually representing the enriched dataset, but can also show raw, unstructured text from the original dataset and other structured variables. By way of example not intended to be limiting, if a user uploads a dataset related to reviews about a product, the widgets 105, 107 could visually represent the product reviews themselves (unstructured text), the enrichments generated from the product reviews (e.g. themes, sentiment), as well as structured variables (e.g. star ratings, number of comments, purchase price).

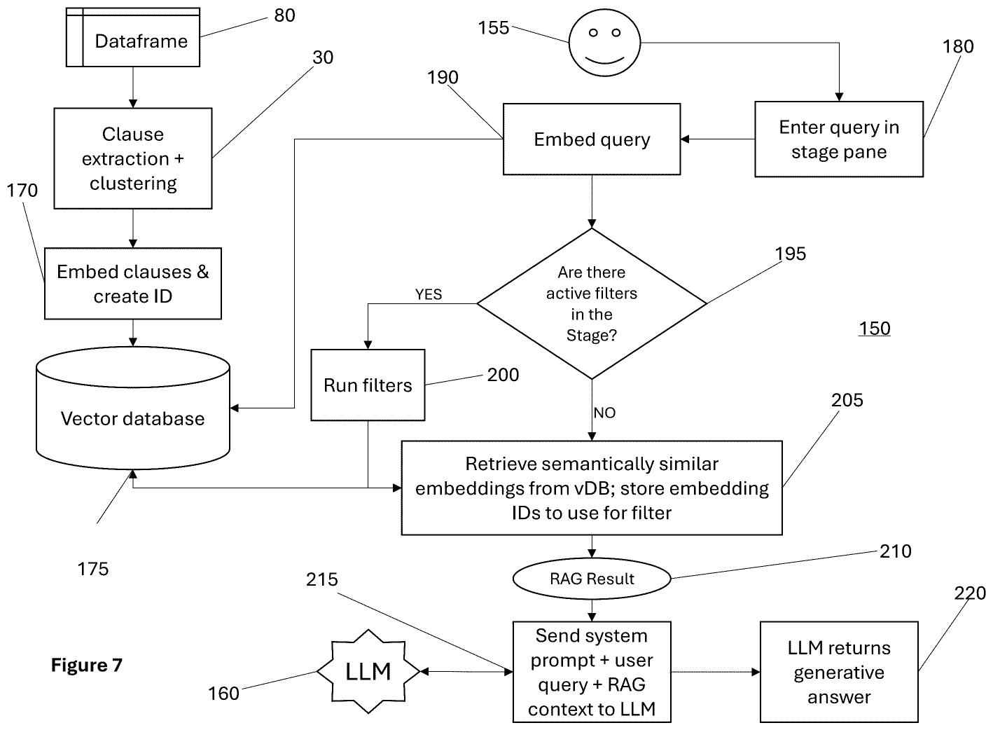

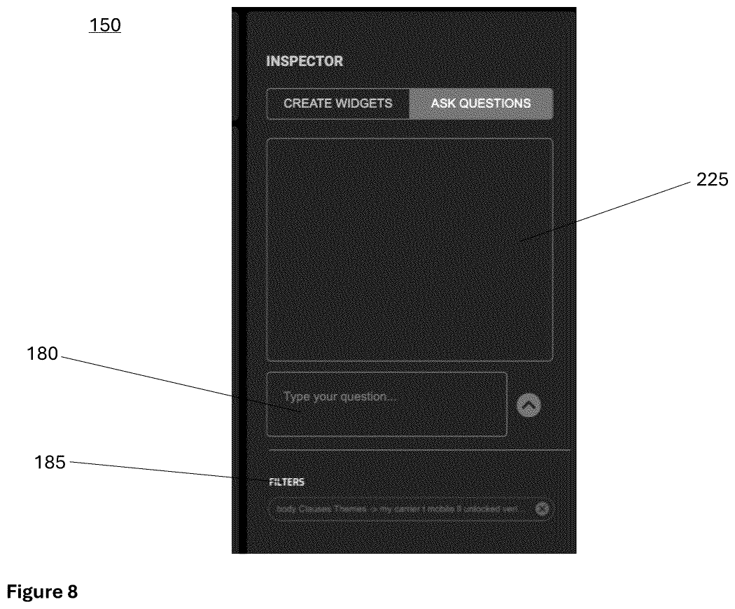

With reference to FIGS. 1, 7 and 8 and according to an embodiment of the present disclosure, the system is further comprised of an interactive data question and answer (Q&A) function 150. FIG. 8 in particular shows a visual representation of the Q&A function 150 as would be displayed on the GUI 50 of the platform 80. The Q&A function 150 enables a user 155 to query the dataset 20 and use a large language model (LLM) 160 to generate answers. The Q&A function 150 also leverages retrieval augmented generation to (RAG) increase the accuracy of the answers and cite the source information used by the LLM 160 in the answer generation. Before being able to utilize the Q&A function 150, the user 155 uploads the dataset 20 onto the platform 80 and generates an enriched dataset 35 by using select enrichers 30. In an embodiment, both clause extraction and clustering enrichers 30 as used. However, in another embodiment, the system does not require the running of the clustering enricher to embed and index the clauses. Instead, the system only utilizes an enricher that indexes the clauses (without clustering them), makes the process faster and less computationally expensive. During the enrichment, the system embeds the clauses 170, creates an identifier (link the embedded clauses to the original dataset 20 and stores the embedded clauses in a vector database 175, such vector databases 175 as known in the art. Once the user 155 navigates to the stage pane (110 as shown in FIG. 6), the user 155 can query the Q&A function 150 through a chat interface 180. The user 155 is also able to create filters 185 to be applied to the queried dataset 20. During operation in a first step 180, the user 155 inputs a query in the chat interface 180. In a second step 190, the system embeds the query and stores the embedded query into the vector database 175. In a third step 195, the system checks whether there are any active filters 185 to be applied. If there are active filters 185, the system runs the filters 185 in a fourth step 200. In a sixth step 205, the system uses a RAG method to find and retrieve, from the vector database 175, clauses that are semantically relevant to the query. If a filter 185 was previously applied, the clauses returned are taken from the filtered clause embeddings; otherwise, they are taken from the clause embeddings 170. The system will also retrieve and include the IDs of clause embeddings. Together, the IDs and the returned clause embeddings constitute the RAG results 210. In a seventh step 215, the system sends the RAG results 210 and the user 155 query to the LLM 160 for processing. In a final step 220, the answer from the LLM 160 is displayed in a display box 225, and the interactive visualization widgets are filtered with the results of the RAG process. In this final step 220, the widgets (not shown) visually represent traits of the retrieved source documents (i.e. the semantically-similar embeddings) that were used by the LLM 160 to generate the answer. This allows users 155 to not only see the answer in the display box 225, but through the widgets (not shown) also visualize the traits of the retrieved source documents and verify what sources were used by the LLM 160 in the generation of that answer.

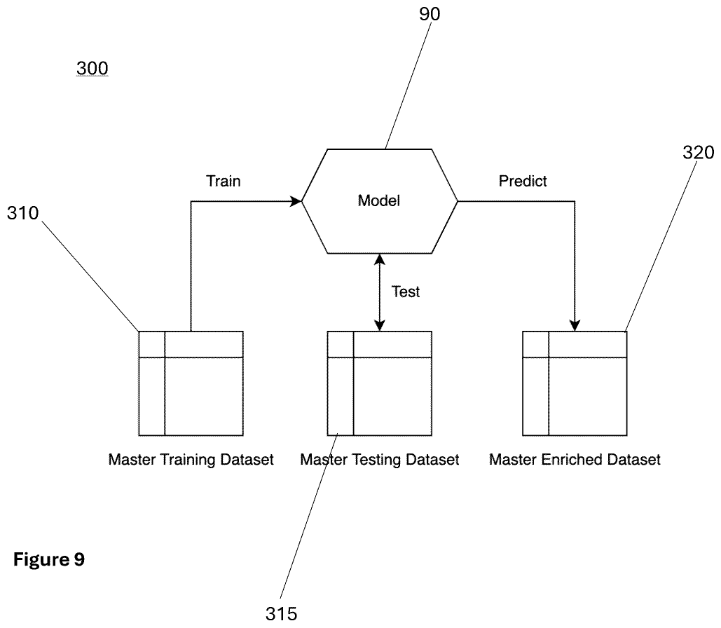

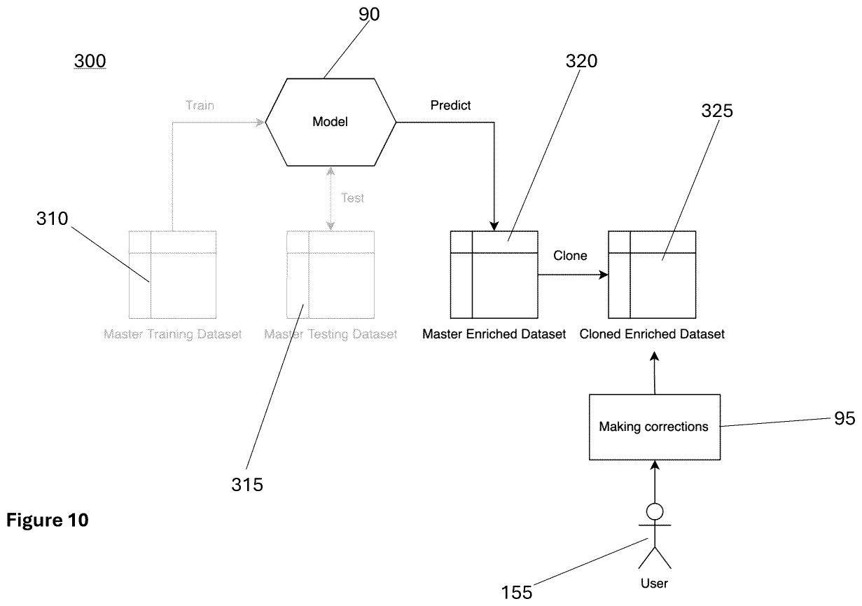

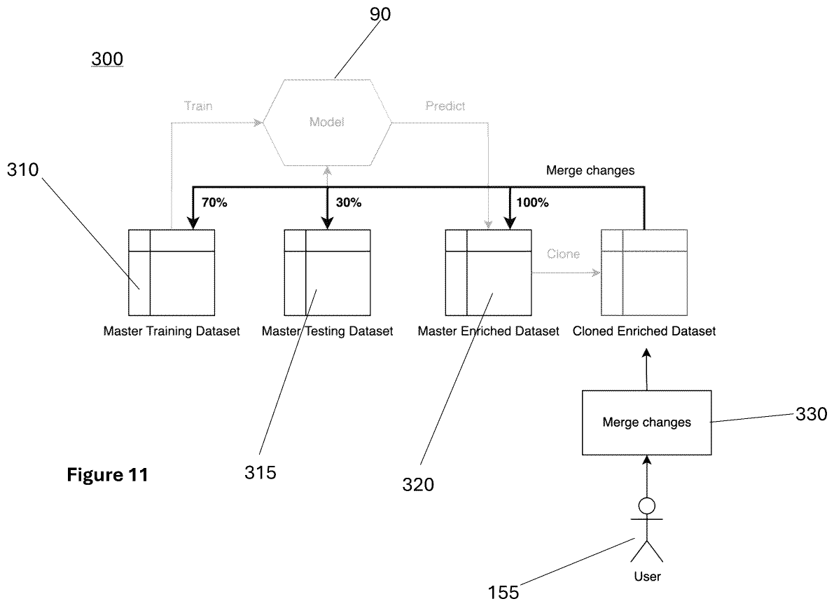

With reference to FIGS. 9, 10 and 11 and according to an embodiment of the present disclosure, the system is comprised of an ongoing learning function 300. The ongoing learning function 300 allows users 155 to train custom models 90 by providing an ability to make corrections 95 to possible mispredictions made by the models 90, and for the system to train a new version of the model 90 using these corrections 95. To do so, the system may be comprised of three master datasets: a master training dataset 310, a master testing dataset 315 and a master enriched dataset 320. The master training dataset 310 begins with 80% of an initial dataset while 20% is reserved for testing. This training dataset is used to train the first version of the model 90, and it grows time with continued user corrections and over inferences produced by the original model while in operation 95 and therefore continuously trains the model 90. A worker skilled in the art would appreciate that the retraining occurs upon an explicit user trigger; however, the system may trigger the retraining automatically upon receipt of a user correction or another desired trigger action. The master testing dataset 315 is the dataset that is used to test each newly trained model 90, and similarly grows over time with continued user corrections 95 and live operational inferences. The master enriched dataset 320 is the dataset that holds all the predictions made by each model 90 across multiple enrichment jobs, as each model 90 goes through ongoing training and testing. As best shown in FIG. 10, when a user 155 makes a correction 95, the system may continue storing predictions in the master enriched dataset 320. As such, the system creates a cloned enriched dataset 325, which is a clone of the master enriched dataset 320. The cloned enriched dataset 325 is used to temporarily store corrections 95 until the user 155 is ready to merge 330 the corrections 95 into the master training, testing and enriched datasets 310, 315, 320. As previously described, the system provides the ability for users 155 to see predictions made by the model 90, review them and correct wrong predictions. The system further allows the user 155 with an opportunity to review corrections 95 before they are merged with the master training, testing and enriched datasets 310, 315, 320. The system also monitors for potential conflicts (i.e. contradictions introduced when making corrections) and requires the user 155 to resolve any contradiction before the merger 330. Indeed, it is an additional feature of the present system to resolve contradictions. For example, if a user corrected a prediction, but a subsequent correction contradicts the original one, the system is designed to flag the contradiction and give the user an opportunity to confirm which prediction is the correct one. Depending on the user's secondary input regarding the contradiction, the system is configured to update the datasets accordingly. When the merger 330 is initiated, the system distributes the corrections 95 among the master training, testing and enriched datasets 310, 315, 320 as specifically shown in FIG. 11. Although the train/test percentage split utilized is 70/30, other combinations may be possible. The system also allows users 155 to trigger training of the model 90 once the sufficiently high enough number of corrections 95 has been made. Such a sufficiently high number will at least depend on the size of the user's 155 dataset. The system trains the original model 90 using the master training dataset 310 and tests the resulting model 90 with the master testing dataset 315. Finally, the user 155 is able to replace an existing “live” model 90 with a newly trained model 90.

For clarity, although the term “model” is utilized, a worker skilled in the art would appreciate that various models exist, as the model evolves with additional training.

Although various embodiments of the present invention have been described and illustrated, it will be apparent to those skilled in the art that numerous modifications and variations can be made without departing from the scope of the invention, which is defined in the appended claims.

1. A method of exploring data, the steps comprising:
receiving at least one dataset;
running an enricher on the at least one dataset, the enricher utilizing at least one of: machine learning, algorithms and artificial intelligence models, to transform the at least one dataset into an enriched dataset;
generating a visual representation of the enriched dataset on a platform, the visual representation containing a plurality of widgets, the plurality of widgets displayed on the platform and configured to be explorable and navigable by a user to determine insights of the at least one dataset.

2. The method of claim 1, wherein a selection by the user of values displayed within the plurality of widgets creates a variety of subsets of the enriched dataset, the subsets of the enriched dataset further represented by secondary widgets.

3. The method of claim 2 wherein the selection by the user of secondary values within the secondary widgets creates further subsets of the enriched dataset, wherein each of the further subsets is selectable for the user to visualize specific information about the at least one dataset.

4. The method of claim 1 wherein the widgets visually represent at least one of: the enriched dataset, unstructured data from the at least one dataset, and structured data from the at least one dataset.

5. The method of claim 1 wherein each one of the plurality of widgets has a type, and the type of the plurality of widgets is automatically generated based on data values of the enriched dataset.

6. The method of claim 1 wherein the enricher is one of: a variable buildable enricher or a built-in enricher.

7. The method of claim 6 wherein the variable buildable enricher is built on the platform using models trained by the user with a specific uploaded dataset.

8. The method of claim 1 wherein the at least one dataset is one of: uploaded by the user and fetched automatically based on a query by the user.

9. The method of claim 1 wherein upon applying the enricher, a clone is generated of the at least one dataset, and the enriched dataset is added to the clone to preserve an integrity of the at least one dataset.

10. A system for exploring data using a platform, the system comprising:
a processor;
a memory in communication with the processor, the memory comprised of computer executable instructions that, when executed by the processor, cause the processor to:
receive the data;
enrich the data to transform the data into an enriched dataset; and,
generate a visual representation of the enriched dataset on a platform, the visual representation containing a plurality of widgets, the plurality of widgets displayed on the platform being explorable and navigable by a user to determine insights of the data.

11. The system of claim 10 wherein the enricher utilizes at least one of: machine learning, algorithms and artificial intelligence (AI) models, to transform the at least one dataset into the enriched dataset.

12. The system of claim 10, wherein a selection by the user of values displayed within the plurality of widgets creates a variety of subsets of the enriched dataset, the subsets of the enriched dataset further represented by secondary widgets.

13. The system of claim 12 wherein the selection by the user of secondary values within the secondary widgets creates further subsets of the enriched dataset, wherein each of the further subsets is selectable for the user to visualize specific information about the data.

14. The system of claim 10 wherein the widgets visually represent at least one of: the enriched dataset, unstructured data from the data, and structured data from the data.

15. The system of claim 10 wherein each one of the plurality of widgets has a type, and the type of the plurality of widgets is automatically generated based on data values of the enriched dataset.

16. The system of claim 10 wherein the enricher is one of: a variable buildable enricher or a built-in enricher.

17. The system of claim 16 wherein the variable buildable enricher is built on the platform using models trained by the user with a specific uploaded dataset.

18. The system of claim 10 wherein the at least one dataset is one of: uploaded by the user and fetched automatically based on a query by the user.

19. The system of claim 10 wherein upon enriching the data, a clone is generated of the data and the enriched dataset is added to the clone to preserve an integrity of the data.
